(19) United States
(12) Patent Application Publication
(10) Pub. No.: US 2017/0323373 A1
(43) Pub. Date: Nov. 9, 2017

(54) DRIVE-THROUGH SHOPPING SYSTEMS AND METHODS

(71) Applicant: OLGA KOSTYUKOVICH, EDMONTON (CA)

(72) Inventor: OLGA KOSTYUKOVICH, EDMONTON (CA)

(21) Appl. No.: 15/147,753

(22) Filed: May 5, 2016

(51) Int. Cl. G06Q 30/06; G06Q 10/08; G06Q 20/12

(52) U.S. Cl. CPC G06Q 30/0641; G06Q 30/0635; G06Q 10/0836; G06Q 20/12

(57) ABSTRACT

A drive-through shopping system includes a drive-through shopping configuration. The drive through shopping configuration may include a parcel of land including a drive-way and a shopping-building. The shopping-building may include a structure and a throughway for a customer. The shopping-building may include a structure including an inventory of goods and the throughway may include at least two convenience-windows accessible by one or more of the customers. A method of using a drive-through shopping system may include: providing access to the drive-through shopping system, receiving a remote order from a customer, retrieving the remote order from an inventory of goods, receiving payment from the customer in exchange for the order, and delivering the order to the customer, with the customer onsite to receive the order.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of retail sales and convenience stores and more specifically relates to drive-through shopping systems and methods.

### 2. DESCRIPTION OF RELATED ART

A drive-through (or sometimes drive-thru) is a variety of service from a business which allows customers to purchase and usually pay for goods, or receive services without leaving their vehicle. Common goods that can be purchased via a drive-though often include food (i.e., fast-food or take-out), where a common service includes banking. Drive-through orders or service requests are often placed using a microphone or given verbally through a window to an attendant and picked-up/delivered to the customer by the same window or a second window.

In many locations, a potential customer may drive to a location to purchase goods and/or services due to distance. Additionally, in many such locations, it is undesirable for a customer to vacate a vehicle due to weather (e.g., excessive heat, excessive cold, precipitation, dust, etc.), for safety concerns (e.g., thieves, criminals, wild animals, etc.), limited mobility (e.g., injury, disability, illness, etc.), or having small children or pets in a vehicle such that a drive-through is the preferred means to acquire goods and/or services. However, the current offering of goods and/or services available via drive-through is quite limited.

Additionally, the methods of placing orders by drive through is often limited to placing an order at the window and waiting for the attendant(s) to fulfill and deliver the order, which may consume a significant amount of time for the customer. It is desirable to provide a customer with alternate means of placing such an order. Therefore a suitable solution is desired to provide a user with a way to purchase and/or take possession of goods/services without exiting a vehicle (e.g., using a mobile application to purchase items).

Several attempts have been made to solve the above-mentioned problems such as those found in Foreign and U.S. patent and Pub. Nos. U.S. Pat. No. 4,901,482 to Lockared et al., U.S. Pat. No. 4,614,059 to Trampe, U.S. Pat. No. 6,661,997 to Ogo, U.S. Pat. No. 4,157,071 to King, US 2006/0076397 to Langos, U.S. Pat. No. 2,638,636 to Pool, US 2008/0092445 to Ramirez, U.S. Pat. No. 6,263,316 to Khan et al., US 2002/0120520 to Hill, JP 2001/227184 to Chiyuki et al., RU 2428364, and JP 2002/358578 to Pool. This art is representative of retail sales. However, none of the above inventions and patents, taken either singly or in combination, is seen to describe the invention as claimed.

Preferably, a drive-through shopping system and method should provide a quick, convenient, and efficient establishment for a customer to purchase retail goods without the need to exit a vehicle and, yet would operate reliably and be manufactured at a modest expense. Thus, a need exists for a reliable drive-through shopping system and method to avoid the above-mentioned problems.

### BRIEF SUMMARY OF THE INVENTION

In view of the foregoing disadvantages inherent in the known retail sales art, the present invention provides a novel drive-through shopping system and method. The general purpose of the present invention, which will be described subsequently in greater detail is to provide a quick, efficient, and safe establishment where a customer may conveniently purchase retail goods without the need to exit his or her vehicle.

A drive-through shopping system is disclosed herein, in a preferred embodiment, comprising a drive-through shopping configuration. The drive through shopping configuration comprises a parcel of land comprising a drive-way and a shopping-building. The shopping-building may comprise a structure and a throughway for a customer. In the preferred embodiment the shopping-building may comprise a structure including an inventory of goods and the throughway may comprise at least two convenience-windows accessible by one or more of the customers. In the preferred embodiment, the at least convenience-windows may be accessible by more than one lane.

In the preferred embodiment the drive-way provides access to at least one public-road for the customer; and the drive-through shopping system allows the customer to approach the drive-through shopping system to purchase goods by an order, without requiring physical entry into the structure by the customer to provide quick, efficient and easy shopping for goods.

Preferably, the goods include groceries and the customer may deliver the specifics of his or her order to a customer-service-representative present verbally through one of the at least two windows. Such specifics may include items that may be discreet in nature (e.g., condoms/birth control, tampons, pain suppressants, specialized soaps, etc.) or necessities such as bread, milk, eggs, water, coffee, etc.). In the preferred embodiment, the customer-service representative picks the order and delivers the order to the customer through one of the windows.

Also disclosed, in a preferred embodiment, is a method of using a drive-through shopping system; the steps may comprise: providing access to the drive-through shopping system, receiving a remote order from a customer, retrieving the remote order from an inventory of goods, receiving payment from the customer in exchange for the order, and delivering the order to the customer, with the customer onsite to receive the order. Additionally, the goods may be placed in the vehicle of the customer, in the preferred embodiment.

The present invention holds significant improvements and serves as a drive-through shopping system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a drive-through shopping system, constructed and operative according to the teachings of the present invention.

FIG. 1 shows a perspective view illustrating a drive-through shopping system comprising a drive-through shopping configuration according to an embodiment of the present invention.

FIG. 2 is a perspective view illustrating a customer-service-representative and a customer placing an order to the customer-service-representative according to an embodiment of the present invention of FIG. 1.

FIG. 3 is a perspective view illustrating the interior of the drive-through-shopping system showing an inventory of goods according to an embodiment of the present invention of FIGS. 1-2.

FIG. 4 is a perspective view illustrating a second-customer-service-representative delivering an order to a customer through a window according to an embodiment of the present invention of FIGS. 1-3.

FIG. 5 is a flowchart illustrating a method of use for the drive-through shopping system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to retail sales and more particularly to a drive-through shopping system and method as used to improve the convenience and availability of goods and services available to a customer by a drive-through location. Generally speaking, a drive-through shopping system may comprise a drive-through shopping configuration constructed on a parcel of land.

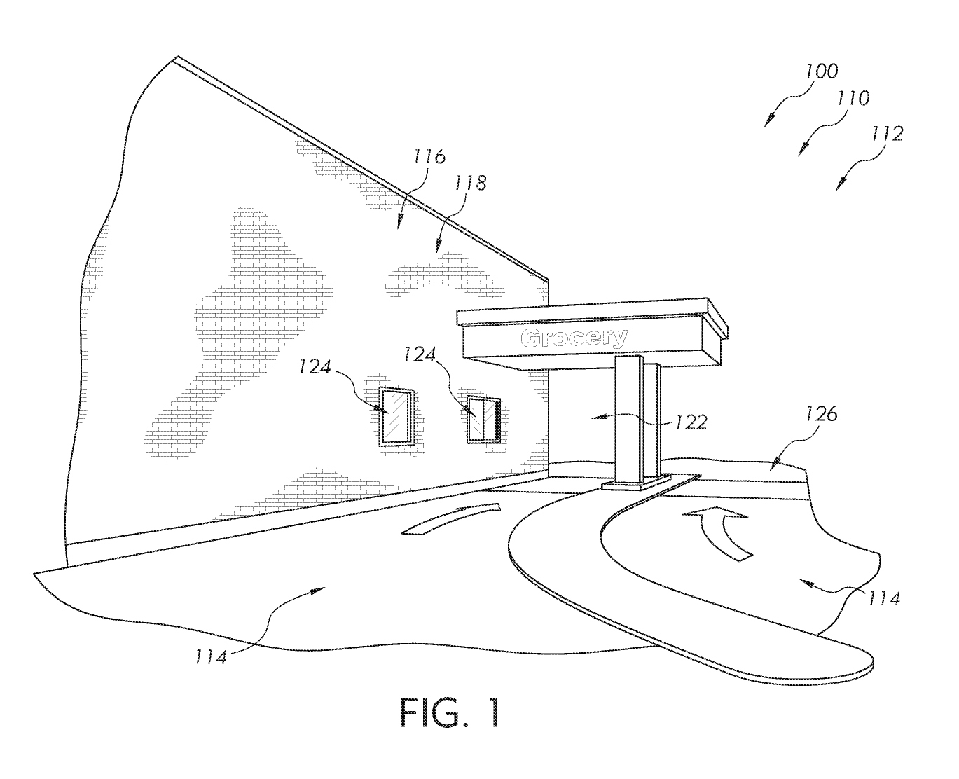

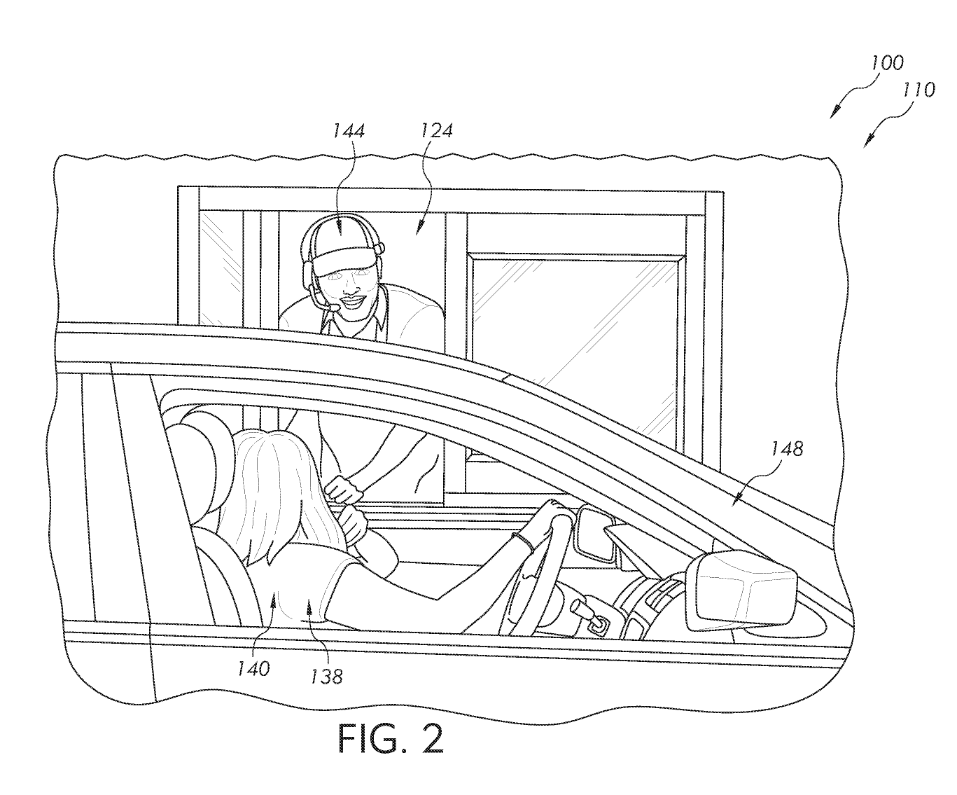

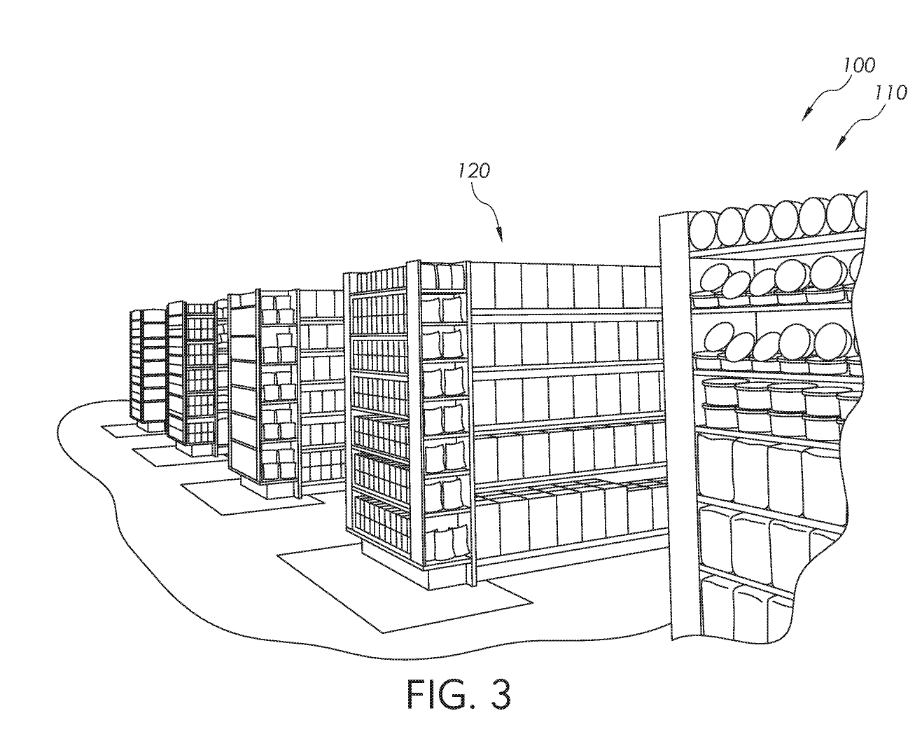

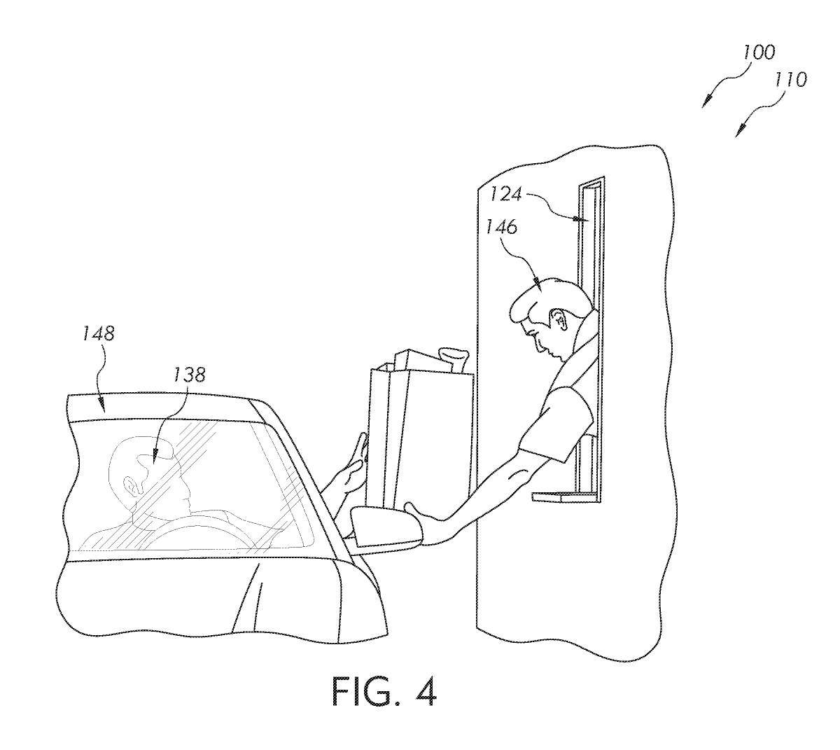

Referring to the drawings by numerals of reference there is shown in FIGS. 1-4, drive-through shopping system 100 may comprise drive-through shopping configuration 110, with drive-through shopping configuration 110 comprising and constructed upon parcel of land 112. Parcel of land 112 may comprise drive-way 114, and shopping-building 116. Drive-way 114 should provide access to at least one public-road 126 for customer 138. Embodiments of drive-through shopping configuration 110 may comprise shopping-building 116 including structure 118; structure 118 may include, at least, inventory of goods 120.

Drive-through shopping configuration 110 may also include throughway 122 for a customer 138. Preferably, throughway 122 comprises at least two convenience-windows 124 accessible by one or more customer(s) 138. Some embodiments may include more or less windows 124, depending upon the specific location and requirements of drive-through shopping configuration 110.

Drive-through shopping system 100 allows customer 138 to approach drive-through shopping system 100 to purchase goods by an order without requiring physical entry into structure 118 by the customer 138. Drive-through shopping system 100 may include shopping-building 116 which may include goods for sale such as groceries.

Customer 138 may provide his or her order verbally to customer-service-representative 144 present at one of at least two windows 124 or by selecting items on a touch-screen. Customer-service-representative 144 may fill the order and provide the order to customer 138 at the same window 124. Some embodiments may include second-customer-service-representative 146 and second window 124. Other embodiments may include more customer-service representatives and more windows.

Customer 138 may provide the order via means other than verbally through window 124. Customer 138 may provide the order via telephone, via internet-website, via mobile-application from a portable electronic device (e.g., cellular phone, tablet computer, smart television, etc.), via text-message, or via facsimile.

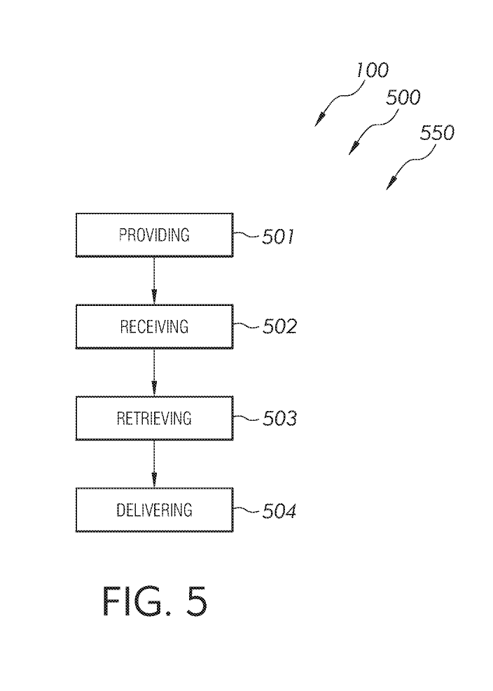

Referring now to FIG. 5 showing flowchart 550 illustrating method of use 500 for drive-through shopping system 100 according to an embodiment of the present invention of FIGS. 1-4. As shown, method of use 500 may comprise the steps of: step one 501, providing access to drive-through shopping system 100; step two 502, receiving a remote order from customer 138; step three 503, retrieving the remote order from inventory of goods 120; step four 504, receiving payment from customer 138 in exchange for the order; and step five 505, delivering the order to customer 138, with customer 138 onsite to receive the order.

In some embodiments of method 500 include inventory of goods 120 comprising grocery items. Other embodiments of method 500 include inventory of goods 120 comprising clothing or hardware-items. Method 500 may include embodiments where the order is received from customer 138 at convenience window 124 by customer-service-representative 144 and may include the same customer-service-representative 144 retrieving the order from inventory of goods 120. However, method 500 may include second-customer-service-representative 146 who retrieves the order from inventory of goods 120. Customer-service-representative 144 may deliver the order to customer 138, or second-customer-service-representative 146 may present the order to customer 138 in embodiments of method 500. Method 500 may also include one of first customer-service-representative 144 or second-customer-service-representative 146 placing the order vehicle 148 of customer 138.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A drive-through shopping system comprising:
a drive-through shopping configuration comprising;
a parcel of land comprising;
a drive-way;
a shopping-building comprising;
a structure including
an inventory of goods;
a throughway for a customer comprising;
at least two convenience-windows accessible by one or more of said customers;
wherein said drive-through shopping system comprises said drive-through shopping configuration;
wherein said drive-through shopping configuration comprises said parcel of land;
wherein said parcel of land comprises said drive-way and said shopping-building;
wherein said shopping-building comprises said structure and said throughway;
wherein said structure comprises at least said inventory of goods;
wherein said drive-way provides access to at least one public-road for said customer; and
wherein said drive-through shopping system allows said customer to approach said drive-through shopping system to purchase goods by an order without requiring physical entry into said structure.

2. The drive-through shopping system of claim 1 wherein said shopping-building includes groceries.

3. The drive-through shopping system of claim 1 wherein said customer provides said order verbally to a customer-service-representative present at one of said at least two windows.

4. The drive-through shopping system of claim 1 wherein said customer-service-representative fills said order and provides said order to said customer.

5. The drive-through shopping system of claim 1 wherein said customer provides said order via telephone.

6. The drive-through shopping system of claim 1 wherein said customer provides said order via internet-website.

7. The drive-through shopping system of claim 1 wherein said customer provides said order via mobile-application.

8. The drive-through shopping system of claim 1 wherein said customer provides said order via text-message.

9. The drive-through shopping system of claim 1 wherein said customer provides said order via facsimile.

10. A method of using a drive-through shopping system comprising the steps of:
providing access to said drive-through shopping system;
receiving a remote order from a customer;
retrieving said remote order from an inventory of goods;
receiving payment from said customer in exchange for said order; and
delivering said order to said customer, said customer onsite to receive said order.

11. The method of claim 10 wherein said inventory of goods comprises grocery items.

12. The method of claim 10 wherein said inventory of goods comprises clothing.

13. The method of claim 10 wherein said inventory of goods comprises hardware-items.

14. The method of claim 10 wherein said order is received from said customer at a convenience-window by a customer-service-representative.

15. The method of claim 10 wherein a customer-service-representative retrieves said order from said inventory of goods.

16. The method of claim 10 wherein a second-customer-service-representative retrieves said order from said inventory of goods.

17. The method of claim 13 wherein said customer-service-representative delivers said order to said customer.

18. The method of claim 14 wherein said second-customer-service-representative presents said order to said customer.

19. The method of claim 13 wherein a second-customer-service-representative presents said order to said customer.

20. The method of claim 10 wherein said order is placed in a vehicle of said customer.
